(19) United States
(12) Patent Application Publication
(10) Pub. No.: US 2023/0126405 A1
(43) Pub. Date: Apr. 27, 2023

(54) NESTABLE WATER TANK AND METHODS OF MANUFACTURING NESTABLE WATER TANKS

(71) Applicant: Coflex S.A. de C.V., Monterrey (MX)

(72) Inventors: Eduardo Coronado, Nuevo Leon (MX); Antonio Garza, Nuevo Leon (MX); Rodrigo Garcia Morlet, Nuevo Leon (MX); Humberto Flores, Col. Chapultepec (MX)

(21) Appl. No.: 17/973,743

(22) Filed: Oct. 26, 2022

Related U.S. Application Data
(60) Provisional application No. 63/272,022, filed on Oct. 26, 2021.

(51) Int. Cl. B65D 90/08; B65D 88/08; E03B 11/02

(52) U.S. Cl. CPC B65D 90/08; B65D 88/08; E03B 11/02

(57) ABSTRACT

The present disclosure relates to a method for manufacturing a nestable water tank, the method comprising molding a water tank comprising a hollow cylindrical body and cutting the water tank to form the nestable water tank comprising a tank body and a lid, wherein the tank body comprises: a side wall comprising a cylindrical shape running along a vertical axis, an interior surface, and an exterior surface; and a bottom connected to a bottom portion of the cylindrical tank, together forming a nestable water tank interior space capable of storing water within the nestable water tank interior space and comprising an interior bottom surface and an exterior bottom surface, wherein at least one of the tank body and the lid are each nestable with other similarly shaped tank bodies and lids.

### CROSS REFERENCE TO RELATED APPLICATIONS

This application claims priority to U.S. Provisional Application No. 63/272,022, filed on Oct. 26, 2021, which is incorporated by reference herein in its entirety for all purposes.

### BACKGROUND

When municipal water supplies are interrupted due to natural disaster or through human intervention, water tanks serve as a back-up storage mechanism to ensure access of a household to a source of potable water. In general, these water tanks are located on top of or within a home to ensure direct and quick access for the home inhabitants. If the tank is located on the rooftop of the home, water may be transferred from the water tank to the household via gravity instead of requiring a pump, which is an important feature during natural disasters in which electricity may also not be available.

Since most water tanks are installed on the top of homes, they must also be transported from a manufacturer or distributor to an installation site residing on the top of the home structure. Given that many water tanks are large enough to contain over 1,000 liters of water, both transportation and installation of the water tanks can become problematic, especially when considering multiple tanks. When storing or transporting multiple water tanks, the tanks must be stacked on top of each other because existing tanks are generally single piece units. This cumbersome stacking of tanks is quite costly to manage due to the large footprint required by the tanks.

Accordingly, there is a need for water tanks that can be stored and transported without having to be stacked at any point during the process. The present disclosure relates to nestable water tanks that can be nested together instead of stacked, one on top of another. Additionally, presented herein are methods of manufacturing nestable water tanks.

### SUMMARY

The present disclosure relates to a method for manufacturing a nestable water tank. The method for manufacturing a nestable water tank includes (a) molding a water tank comprising a hollow cylindrical body; and (b) cutting the water tank along a horizontal plane of the cylindrical body to form the nestable water tank comprising a tank body and a lid. The tank body may include (i) a side wall comprising a cylindrical shape running along a vertical axis, an interior surface, and an exterior surface. The tank body may include a bottom connected to a bottom portion of the cylindrical tank, together forming a nestable water tank interior space capable of storing water within the nestable water tank interior space and comprising an interior bottom surface and an exterior bottom surface. In some embodiments, the lid may include (i) a top lid portion connected to a side wall and comprising a top surface and a bottom surface; and (ii) the side wall comprising a bottom surface and a top surface that may be connected to the bottom surface of the top lid portion, the side wall forming a hollow cylinder running along the vertical axis and comprising an inside surface and an outside surface. At least one of the tank body may be nestable with other similarly shaped tank bodies and the lid may be nestable with other similarly shaped lids.

Molding a water tank may include (i) heating a polymer to a temperature ranging from about 180° C. to about 240° C. to form a melted polymer; and (ii) extruding a melted polymer into a hollow mold shell to form an extruded polymer. Molding the water tank may include (iii) pressing air from a compressed air source into the extruded polymer to inflate the extruded polymer to fill the hollow mold, forming an inflated water tank; and (iv) cooling the inflated polymer water tank to a temperature ranging from about 25° C. to about 60° C. to form the water tank. Molding the water tank may include forming at least one lifting hole on a rim protruding in a horizontal plane away from the exterior surface of the side wall. Assembling the water tank may include fastening the lid to the tank body using at least one of an adhesive, a threaded connection, a sleeve, a compression union, a nut, a bolt, a clamp, a lock, and a wire.

In some embodiments, molding a water tank may include (i) filling a hollow mold with a polymer; and (ii) rotating the hollow mold along at least one axis at a rotational speed ranging from about 1 rpm to about 100 rpm to form a rotating mold containing the polymer. Molding a water tank may include (iii) heating the rotating mold and the polymer contained therein to a temperature ranging from about 240° C. to about 280° C. of the hollow mold to form a melted polymer; (iv) cooling the melted polymer to a temperature ranging from about 35° C. to about 70° C. while the melted polymer continues to rotate to form a cooled polymer; and (v) stopping rotation of the cooled polymer to form the water tank. Manufacturing the water tank may include forming a cap port on the top lid portion, wherein the cap port may have a diameter ranging from about 25 cm to about 75 cm. Manufacturing the water tank may include forming a fill valve orifice through the side wall of the lid, wherein the fill valve orifice comprises a diameter ranging from about 10 mm to about 35 mm. Manufacturing the water tank may include forming a drain outlet on the side wall of the tank body, wherein the drain outlet may have a diameter ranging from about 20 mm to about 50 mm, wherein the drain outlet comprises a plane recess having a length and width, each ranging from about 60 mm to about 100 mm, and wherein the plane recess may have a depth ranging from about 1 mm to about 25 mm. Manufacturing the water tank may include forming at least one perforated protrusion in a lid that extends from a side wall of the lid. The perforated protrusion may be configured to receive a bolt for fastening the lid to the tank body. Manufacturing the water tank may include forming at least one bolt hole on a rim protruding in a horizontal plane away from an exterior surface of the side wall, the at least one bolt hole configured to receive a bolt for fastening the lid to the tank body.

A polymer may include one or more of a polyethylene, a low-density polyethylene, a high-density polyethylene, a linear low-density polyethylene, an ultra-high-molecular weight polyethylene, a medium-density polyethylene, a cross-linked polyethylene, a polyethylene terephthalate, and a polypropylene. A polymer may have a thickness ranging from about 0.5 mm to about 10 mm. The polymer may have a color comprising one or more of a black, a white, a red, an orange, a yellow, a green, a blue, an indigo, and a violet.

According to some embodiments, a tank body may be nestable with from about 1 to about 20 similarly shaped tank bodies. A lid may be nestable with from about 1 to about 20 similarly shaped lids. Both of the tank body and the lid are nestable together with from about 1 to about 20 similarly shaped tank body and lid combinations. A nestable water tank may have a volume ranging from about 250 liters to about 5,000 liters. In some embodiments, a nestable water tank may include multiple layers formed through the molding process. For example, molding a water tank may include molding a multilayer tank, wherein, upon cutting the water tank, forms the nestable water tank comprising the tank body and the lid that each include from 1 layer to 5 layers

### BRIEF DESCRIPTION OF THE DRAWINGS

Some embodiments of the disclosure may be understood by referring, in part, to the present disclosure and the accompanying drawings, wherein:

FIG. 1 illustrates an isometric perspective view of a molded water tank that has not been cut, according to a specific example embodiment of the disclosure;

FIG. 2A illustrates an isometric perspective view of a molded water tank that has not been cut, according to a specific example embodiment of the disclosure;

FIG. 2B illustrates a front view of the molded water tank of FIG. 2A, according to a specific example embodiment of the disclosure;

FIG. 2C illustrates a side view of the molded water tank of FIG. 2A, according to a specific example embodiment of the disclosure;

FIG. 2D illustrates a top view of the molded water tank of FIG. 2A, according to a specific example embodiment of the disclosure;

FIG. 2E illustrates a bottom view of the molded water tank of FIG. 2A, according to a specific example embodiment of the disclosure;

FIG. 3A illustrates a side view of a molded water tank that highlights a cutting region of the molded water tank that may be used to form a nestable water tank, according to a specific example embodiment of the disclosure;

FIG. 3B illustrates a zoomed in view of the cutting region of the molded water tank of FIG. 3A, according to a specific example embodiment of the disclosure;

FIG. 4A illustrates a side view of a nestable water tank that has been cut from a water tank to form a lid and a tank body and then fitted together with a lid cap being secured to the cap port, according to a specific example embodiment of the disclosure;

FIG. 4B illustrates a zoomed in view of the fitted together region of the nestable water tank from FIG. 4A, according to a specific example embodiment of the disclosure;

FIG. 5 illustrates an isometric perspective view of a nestable water tank that has been cut from a molded water tank to form a lid and a tank body and then fitted together along with a lid cap, according to a specific example embodiment of the disclosure;

FIG. 6A illustrates an isometric perspective view of a nestable water tank that has been cut to form a lid and a tank body and then fitted together along with a lid cap, according to a specific example embodiment of the disclosure;

FIG. 6B illustrates an exploded perspective view of the nestable water tank from FIG. 6A, according to a specific example embodiment of the disclosure;

FIG. 6C illustrates a front view of the nestable water tank according to FIG. 6A, according to a specific example embodiment of the disclosure;

FIG. 6D illustrates a top view of the nestable water tank according to FIG. 6A, according to a specific example embodiment of the disclosure;

FIG. 6E illustrates a side view of the nestable water tank according to FIG. 6A, according to a specific example embodiment of the disclosure;

FIG. 7 illustrates a front view of five nestable water tank bodies nested together, according to a specific example embodiment of the disclosure;

FIG. 8 illustrates a cross-sectional side view of five nestable water tank bodies nested together, according to a specific example embodiment of the disclosure;

FIG. 9A illustrates a top perspective view of a nestable tank lid, according to a specific example embodiment of the disclosure;

FIG. 9B illustrates a bottom perspective of a nestable tank lid, according to a specific example embodiment of the disclosure;

FIG. 10 illustrates a cross-sectional side view of five nestable tank lids that are nested, according to a specific example embodiment of the disclosure;

FIG. 11 illustrates a side view of five nestable tanks that are nested with both the tanks and the lids, according to a specific example embodiment of the disclosure; and

FIG. 12 illustrates a side view of five nestable tanks nested together and five lids that are nested together, according to a specific example embodiment of the disclosure.

### DETAILED DESCRIPTION

The present disclosure relates, in some embodiments, to nestable water tanks and methods of manufacturing nestable water tanks. The nestable water tanks disclosed herein may be nested together with other similarly shaped nestable water tanks. Nesting of the nestable water tanks permits storage and transportation of the nested nestable water tanks without having to be stacked, one on top of the other, at any point during the process, which advantageously reduces the comparative space footprint required for the nestable water tanks in comparison to known water tanks. For example, five nested nestable water tanks may take up less space than two stacked water tanks known in the art. Taking up less space reduces the cost and work associated with storing, transporting, and installing the nestable water tanks in comparison to known water tanks that must instead be stacked or placed side-by-side. Disclosed nestable water tanks may be manufactured (e.g., blow molded, rotomolded) as one piece and then cut along a horizontal plane of the nestable water tank, which advantageously permits the nestable water tanks to be constructed while producing less material, work, and monetary waste in comparison to multi-part water tanks that are manufactured as separate components.

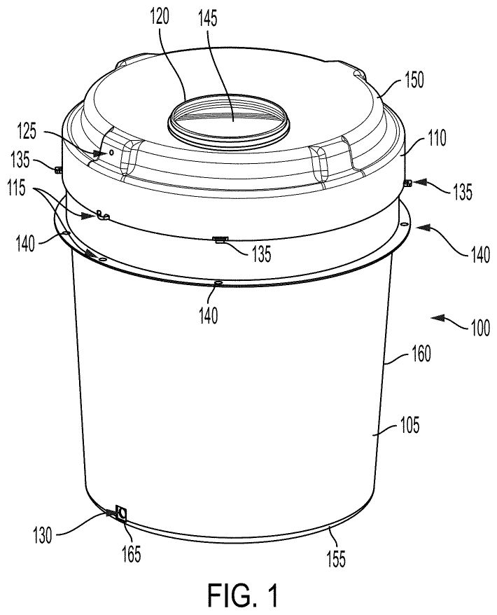

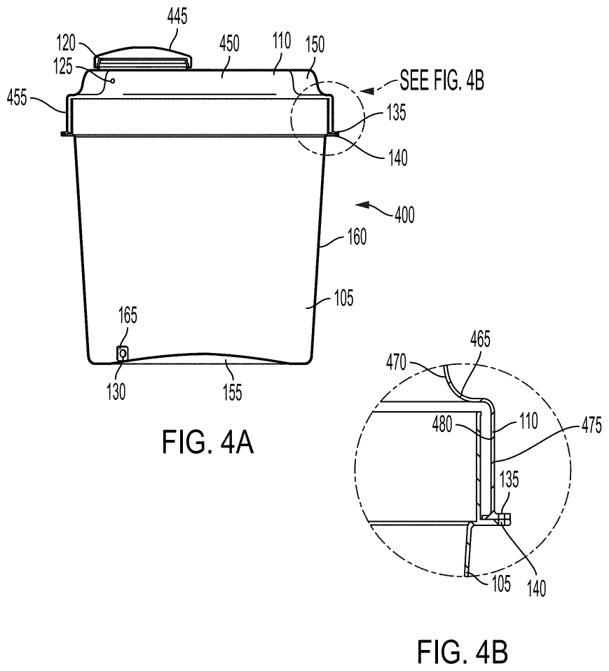

FIG. 1 illustrates an isometric perspective view of a molded water tank 100 that has not yet been cut to form a nestable water tank. As is shown in FIG. 1, a disclosed water tank may include a hollow body 145 that may be generally cylindrical in shape. In some embodiments, a water tank may include other shapes including a cuboid, a horizontal cylinder, a cone, a rectangular prism, a sphere, a triangular prism, a square prism, a pentagonal prism, a hexagonal prism, an octagonal prism, a square-based pyramid, each of which may be nested as well. The water tank may include a top portion 150, a bottom portion 155, and a cylindrical side wall 160 that connects the top portion 150 to the bottom portion 155. A top portion 150 may include a cap port 120 that may also be used as an access point during the manufacturing process of the molded water tank 100. This cap port 120 may also provide access to the interior of the molded water tank 100 or the nestable water tank 400 (see FIG. 4) for cleaning and maintenance of tank and fill valve orifice 125 after installation. Molding of the nestable water tank 400 may include blow molding and rotomolding. Molding may include the cap port 120 as the access point for providing the air pressure necessary to mold an initial nestable water tank shape, whereas a final disconnection between the molding apparatus and the nestable water tank will leave the cap port 120 formed. In some embodiments, the cap port 120 may be formed by cutting into a lid 110 of the water tank. In some embodiments, molding of the water tank may include molding a single layer tank body 105 and/or lid 110 as well as molding a multilayer tank body 105 and/or lid 110. Each of a tank body 105 and lid 110 may include from 1 layer to 5 layers. A tank body 105 or a lid 110 may each include 1 layer, or 2 layers, or 3 layers, or 4 layers, or 5 layers.

In some embodiments, blow molding includes heating a polymer using a heat source to a temperature ranging from about 180° C. to about 220° C. to form a melted polymer. A polymer may be heated to a temperature of about 180° C., or about 185° C., or about 190° C., or about 195° C., or about 200° C., or about 205° C., or about 210° C., or about 215° C., or about 220° C., where about includes plus or minus 2.5° C. Any heat source known in the art may be used, including a heat gun, electrical heat, hot fluids (e.g., water, oil), hot air, and combinations thereof. The melted polymer may be extruded into a hollow mold shell to form an extruded polymer. The extruded polymer may then be exposed to air from a compressed air source to inflate the extruded polymer to have the general shape of the mold, forming an inflated polymer water tank. Blow molding may include cooling the inflated polymer water tank to a temperature ranging from about 25° C. to about 60° C. to form the water tank. Blow molding may include cooling the inflated polymer water tank to a temperature of about 25° C., or about 30° C., or about 35° C., or about 40° C., or about 45° C., or about 50° C., or about 55° C., or about 60° C., where about includes plus or minus 2.5° C. Cooling may be done by removing the heat source, turning off the heat source, or by adding a cooling source such as cool air or ice.

According to some embodiments, a water tank may be formed by rotomolding, which includes rotating a mold along at least one axis where the mold contains a heated polymer that then sticks to the inside walls of the mold to form the shape of the water tank. Upon cooling, the water tank is formed. Rotomolding may include filling a hollow mold with a polymer (e.g., polymer pellets) and rotating the hollow mold along at least one axis at a rotational speed ranging from about 1 rpm to about 100 rpm to form a rotating mold containing the polymer. The hollow mold may be rotated along one or more of a y-axis, an x-axis, a z-axis, and axis therein between. The rotating mold containing the polymer may be heated to a temperature ranging from about 240° C. to about 280° C. to form a melted polymer. The rotating mold containing the polymer may be heated to a temperature of about 240° C., or about 245° C., or about 250° C., or about 255° C., or about 260° C., or about 265° C., or about 270° C., or about 275° C., or about 280° C., where about includes plus or minus 2.5° C. Heating the polymer will fuse the polymer pellets together to form the shape of the water tank. The melted polymer may be cooled to a temperature ranging from about 35° C. to about 70° C. while the melted polymer continues to rotate to form a cooled polymer having the shape of the inside surface of the hollow mold. The melted polymer may be cooled to a temperature of about 35° C., or about 40° C., or about 45° C., or about 50° C., or about 55° C., or about 60° C., or about 65° C., or about 70° C., where about includes plus or minus 2.5° C. Rotomolding may include a step of stopping rotation of the cooled polymer so that the water tank may be separated from the mold.

A polymer used in molding of a water tank may include one or more of a polyethylene, a low-density polyethylene, a high-density polyethylene, a linear low-density polyethylene, an ultra-high-molecular weight polyethylene, a medium-density polyethylene, a cross-linked polyethylene, a polyethylene terephthalate, a polypropylene, and copolymers thereof. In some embodiments, a polymer used may include a polycarbonate, an acrylic, a polyamide, a polystyrene, an acrylonitrile butadiene styrene, a polyester, and copolymers thereof. Once a water tank has been formed by a polymer, the polymer water tank may have a thickness ranging from about 0.5 mm to about 10 mm. The polymer water tank may have a thickness of about 0.5 mm, or about 1.0 mm, or about 2.0 mm, or about 3.0 mm, or about 4.0 mm, or about 5.0 mm, or about 6.0 mm, or about 7.0 mm, or about 8.0 mm, or about 9.0 mm, or about 10.0 mm, where about includes plus or minus 0.5 mm. The polymer water tank may have any color, including one or more of a black, a white, a red, an orange, a yellow, a green, a blue, an indigo, and a violet.

As is shown in FIG. 1, a water tank may include a drain outlet 130 on a side wall 160 of a tank body 105. Both the molded water tank 100 (FIG. 1) and the nestable water tank 400 (FIG. 4) cut from the water tank may include the drain outlet 130. The drain outlet 130 may be configured to release water from the inside of the molded water tank 100 or the nestable water tank 400. The drain outlet 130 may have a diameter ranging from about 10 mm to about 50 mm. The drain outlet 130 may have a diameter of about 10 mm, or about 15 mm, or about 20 mm, or about 25 mm, or about 30 mm, or about 35 mm, or about 40 mm, or about 45 mm, or about 50 mm, where about includes plus or minus 2.5 mm. In some embodiments, the drain outlet 130 may include a drain recess 165 for fitting an assembly to the drain outlet 130. A drain recess 165 may include a recess that resides within the side wall 160 of the tank body 105. A drain recess 165 may be any general shape including having a square, circle, or polygonal cross-section. For example, a drain recess 165 may have a generally square cross-section. The drain recess 165 may have a length ranging from about 60 mm to about 100 mm. The drain recess 165 may have a length of about 60 mm, or about 70 mm, or about 80 mm, or about 90 mm, or about 100 mm, where about includes plus or minus 5 mm. The drain recess 165 may have a width ranging from about 60 mm to about 100 mm. The drain recess 165 may have a width of about 60 mm, or about 70 mm, or about 80 mm, or about 90 mm, or about 100 mm, where about includes plus or minus 5 mm. The drain recess 165 may have a depth with respect to the outside surface of the side wall 160 ranging from about 1 mm to about 25 mm. The drain recess 165 may have a depth with respect to the outside surface of the side wall 160 of about 1 mm, or about 5 mm, or about 10 mm, or about 15 mm, or about 20 mm, or about 25 mm, where about includes plus or minus 2.5 mm.

A molded water tank 100, as is shown in FIG. 1, may include a fill valve orifice 125 through a side wall 160 of a tank body 105. Similarly, as is shown in FIG. 4, a nestable water tank 400 may also include a fill valve orifice 125 through a side wall of a lid 110. A fill valve orifice 125 may have any general shape including a circle, an oval, a square, a rectangle, a polygon, and others. For example, a fill valve orifice 125 may be a circle having a diameter ranging from about 10 mm to about 35 mm. The fill valve orifice 125 may be a circle having a diameter of about 10 mm, or about 15 mm, or about 20 mm, or about 25 mm, or about 30 mm, or about 35 mm, where about includes plus or minus 2.5 mm. If polygonal, a fill valve orifice 125 may have a length ranging from about 10 mm to about 50 mm and a width ranging from about 10 mm to about 50 mm. The fill valve orifice 125 may have a length of about 10 mm, or about 20 mm, or about 30 mm, or about 40 mm, or about 50 mm, where about includes plus or minus 5 mm. The fill valve orifice 125 may have a width of about 10 mm, or about 20 mm, or about 30 mm, or about 40 mm, or about 50 mm, where about includes plus or minus 5 mm. In some embodiments, a water tank may include more than one fill valve orifice 125. For example, a water tank may include from 1-10 fill valve orifices.

A molded water tank 100, as shown in FIG. 1, may include one or more lifting holes 115 on a rim that protrudes along a horizontal plane away from an exterior surface of the side wall 160. A water tank may include one lifting hole 115, two lifting holes 115, three lifting holes 115, four lifting holes 115, five lifting holes 115, six lifting holes 115, seven lifting holes 115, eight lifting holes 115, nine lifting holes 115, ten lifting holes 115, or more lifting holes 115. Lifting holes 115 may be advantageously used for transporting and storing a tank body 105. The water tank may include at least one bolt hole 140 in a rim protruding in a horizontal plane away from the exterior surface of the side wall 160. The at least one bolt hole 140 is configured to receive a bolt for fastening the lid 110 to the tank body 105. The water tank may include one bolt hole 140, two bolt holes 140, three bolt holes 140, four bolt holes 140, five bolt holes 140, six bolt holes 140, seven bolt holes 140, eight bolt holes 140, nine bolt holes 140, ten bolt holes 140, or more bolt holes 140. The water tank may include a protruding bolt hole 135 on the lid 110. The protruding bolt hole 135 may be fastened with a bolt or similar device to a bolt hole 140 located on the rim, protruding in a horizontal plane away from the exterior surface of the side wall 160. Fastening at least one bolt hole 140 from the tank to at least one bolt hole 135 from the lid 110 may secure the lid 110 to the tank.

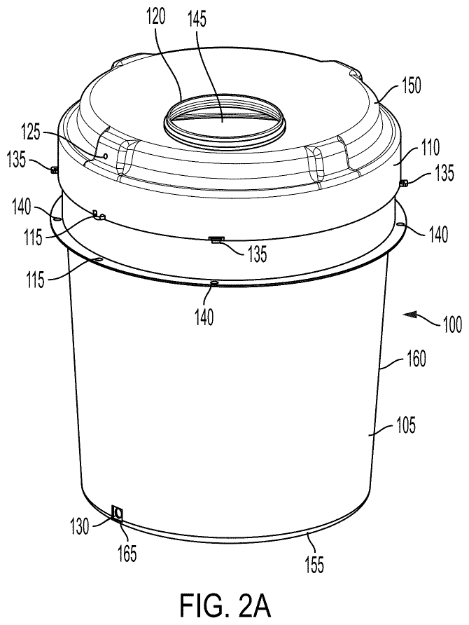

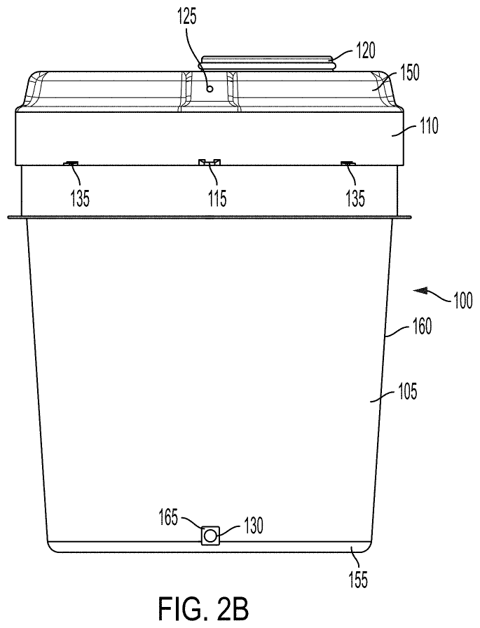

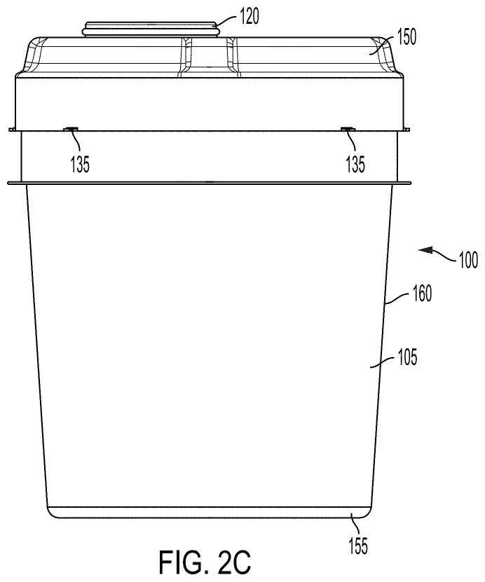

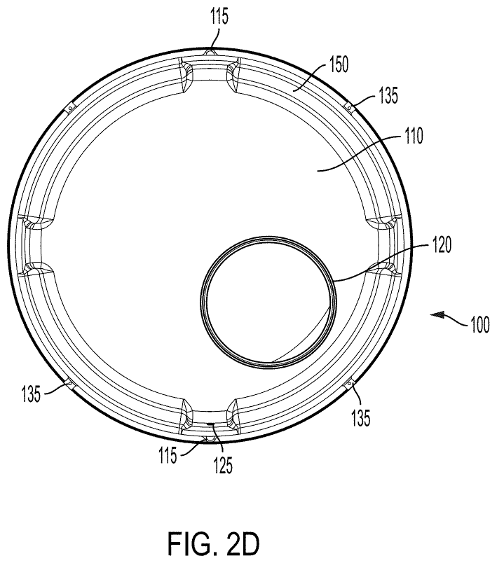

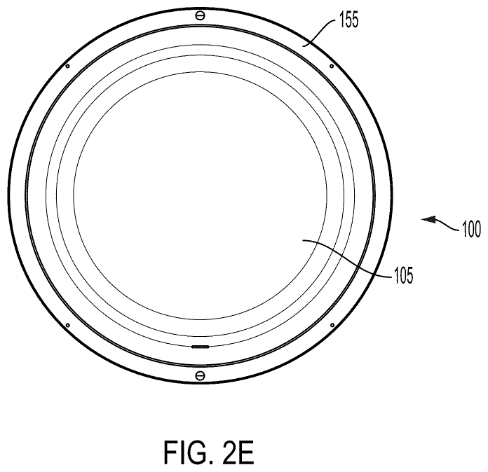

FIGS. 2A-2E illustrate various views of a molded water tank 100 that has not been cut. Specifically, FIG. 2A illustrates an isometric perspective view of a molded water tank 100. FIG. 2B illustrates a front view of the molded water tank 100. FIG. 2C illustrates a side view of the molded water tank 100. FIG. 2D depicts a top view of the molded water tank 100 and FIG. 2E illustrates a bottom view of the molded water tank 100.

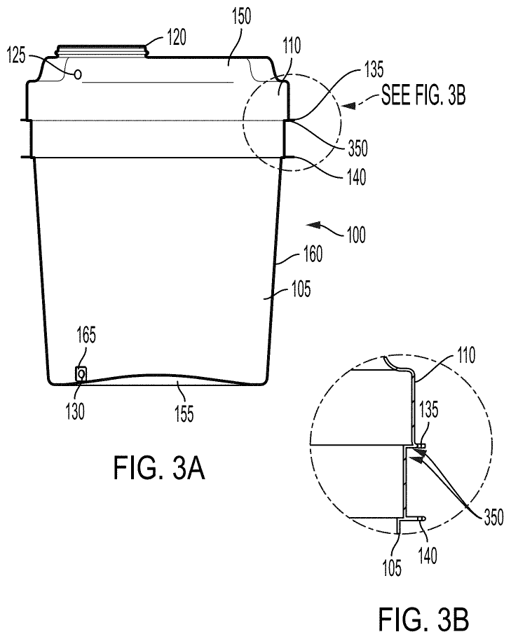

FIGS. 3A and 3B illustrates a side view of a molded water tank 100 that highlights the cutting region 350 of the molded water tank 100 that may be used to form a nested water tank 400 (See FIG. 4). In some embodiments, a molded water tank 100 may be cut along a horizontal plane, a vertical plane, or any plane therebetween to form a lid 110 and a tank body 105 of a nestable water tank 400. A method for manufacturing a nestable water tank 400 may include a step of cutting the molded water tank 100 along a horizontal plane of the cylindrical body to form the nestable water tank 400 comprising a tank body 105 and a lid 110. A molded water tank 100 may be cut in any conventional way known. For example, a molded water tank 100 may be cut by a saw, including a fine-toothed saw, a jigsaw, a table saw, an oscillating saw, a radial arm saw, a panel saw, a reciprocating saw, a band saw, a rotary saw, a track saw, and others. A molded water tank 100 may be cut with a laser cutter. For example, a laser cutter includes a gas laser (e.g., CO₂ laser), a fiber laser, and a crystal laser (e.g., vanadate crystal laser).

FIGS. 4A-4B illustrate a side view of a nestable water tank 400 that has been cut from a molded water tank 100 to form a lid 110 and a tank body 105 and then fitted together with a lid cap 445 being secured to the cap port 120. As is shown in FIGS. 4A-4B, a nestable water tank 400 may include a tank body 105. The tank body 105 may include a side wall 160 having a generally cylindrical shape running along a vertical axis, an interior surface, and an exterior surface. A tank body 105 may include a side wall 160 that may be connected to a bottom portion 155 of the cylindrical tank, together forming a nestable water tank 400 having an interior space capable of storing water within the nestable water tank 400 interior space and comprising an interior bottom surface (not visible) and an exterior bottom surface of the bottom portion 155. A nestable water tank 400 may include a lid 110. The lid 110 may include a top lid portion 450 connected to a side wall 455. The top lid portion 450 may have a top surface 465 and a bottom surface 470. The top lid portion 450 may be connected to a side wall 455 of the lid 110. The side wall 455 may have an interior surface 480 that is connected to the interior surface 470 of the top lid portion 450. The side wall 455 may have an exterior surface 475 that is connected to the exterior surface 465 of the top lid portion 450. The side wall 160 may form a hollow cylinder running along a vertical axis of the nestable water tank 400. The side wall 160 may have an inside surface and an outside surface. At least one of the tank body 105 and the lid 110 may be nestable with one or more similarly shaped tank bodies or lids 110.

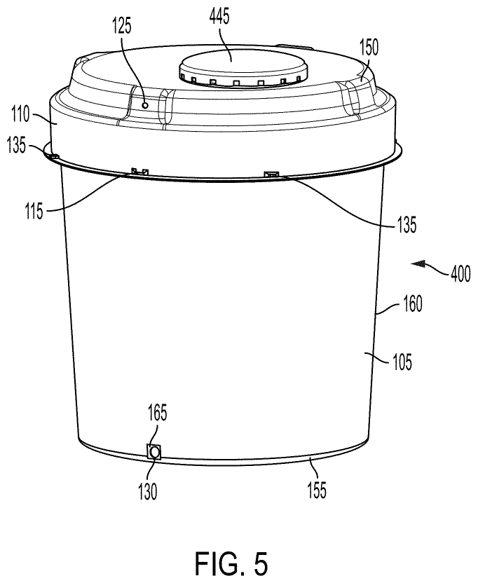

FIG. 5 illustrates an isometric perspective view of a nestable water tank 400 that has been cut from a molded water tank 100 to form a lid 110 and a tank body 105 and then fitted together along with a lid cap 445. In some embodiments, a nestable water tank 400 may have a volume ranging from about 250 liters to about 10,000 liters. For example, the nestable water tanks 400 disclosed herein may have a volume of about 750 liters or about 1,100 liters. The disclosed nestable water tanks 400 may have a volume of about 250 liters, or about 500 liters, or about 750 liters, or about 1,000 liters, or about 1,250 liters, or about 1,500 liters, or about 1,750 liters, or about 2,000 liters, or about 2,250 liters, or about 2,500 liters, or about 2,750 liters, or about 3,000 liters, or about 3,250 liters, or about 3,500 liters, or about 3,750 liters, or about 4,000 liters, or about 4,250 liters, or about 4,500 liters, or about 4,750 liters, or about 5,000 liters, where about includes plus or minus 125 liters. A nestable water tank 400 may have a height ranging from about 1 meter to about 10 meters. For example, a nestable water tank 400 may have a height of about 1 meter, or about 2 meters, or about 3 meters, or about 4 meters, or about 5 meters, or about 6 meters, or about 7 meters, or about 8 meters, or about 9 meters, or about 10 meters, where about includes plus or minus 0.5 meters. A nestable water tank 400 may have a diameter ranging from about 1 meter to about 10 meters. For example, a nestable water tank 400 may have a diameter of about 1 meter, or about 2 meters, or about 3 meters, or about 4 meters, or about 5 meters, or about 6 meters, or about 7 meters, or about 8 meters, or about 9 meters, or about 10 meters, where about includes plus or minus 0.5 meters.

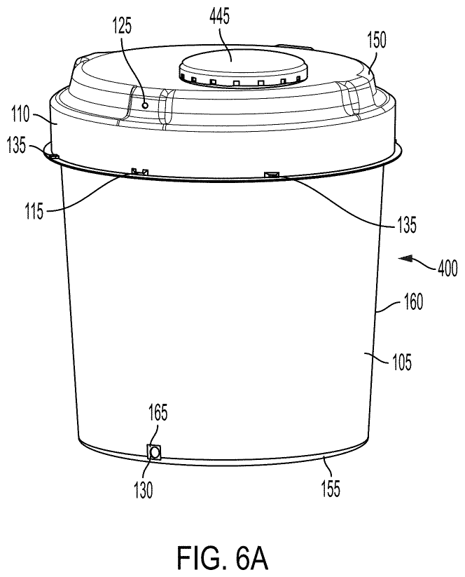

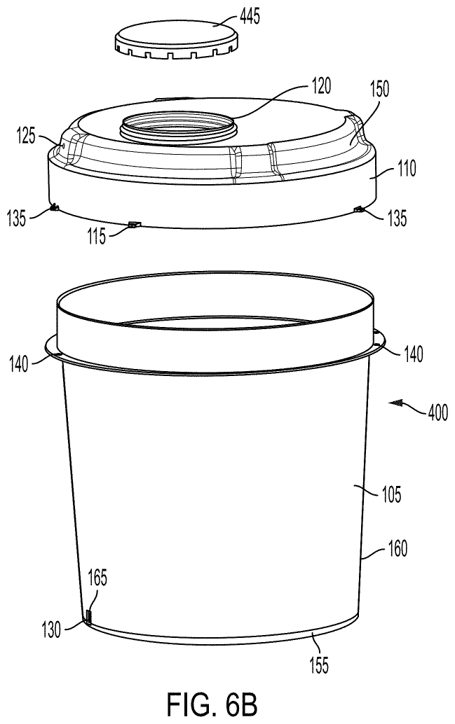

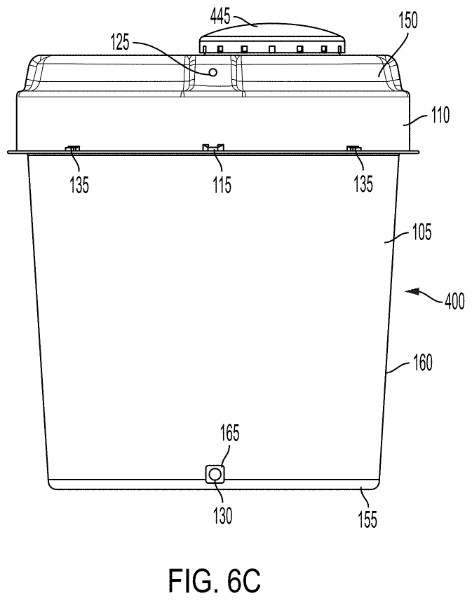

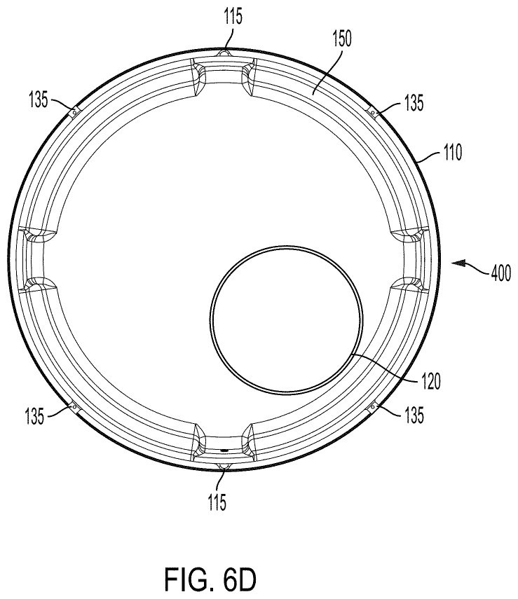

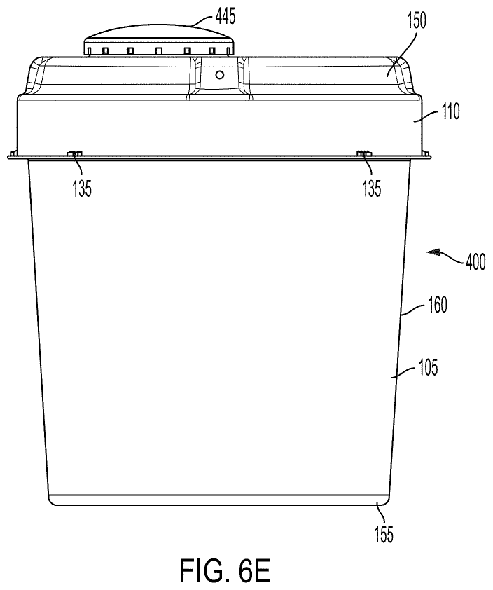

FIGS. 6A-6E illustrate various views of a nestable water tank 400 formed by cutting a molded water tank 100. FIG. 6A depicts an isometric perspective view of a nestable water tank 400 where FIG. 6B shows an exploded perspective view of the nestable water tank 400 where the tank body 105, lid 110, and lid cap 445 have been separated from each other. In some embodiments, a lid cap 445 may be any diameter that permits it to secure to a cap port 120 of the lid 110. A cap port 120 may have a diameter ranging from about 10 cm to about 75 cm and a lid cap 445 may have a diameter ranging from about 10 cm to about 80 cm. A lid cap 445 and a cap port 120 may each be threaded so that the lid cap 445 may be threadably fastened to the cap port 120. A lid cap 445 and a cap port 120 may be connected through any one of an adhesive, a nut, a bolt, a clamp, and a wire. A lid cap 445 may provide an air tight or liquid tight seal with a cap port 120. In some embodiments, the lid cap 445 may not be air tight or liquid tight, but may instead be loose. The lid cap 445 may form a secure connection with the cap port 120 through any general means, including snapping, threadably coupling, adhesion, friction coupling, or just through gravity. A lid cap 445 may be sealed to the cap port 120 with an adhesive or a weld. A lid cap 445 may be attached to a cap port 120 through a tether or hinge, or may be completely separable. In some embodiments, a cap port 120 may be flush with a top surface of the lid 110. The cap port 120 may also protrude upwards or recess inwards with respect to the top surface of the lid 110. The cap port 120 may be threaded as to receive the lid cap 445. The lid cap 445 may be threaded and configured to threadably connect to a cap port 120.

A lid 110 may connect to a tank body 105 through any means. For example, a lid 110 may connect to a tank body 105 through using one or more of an adhesive, a threaded connection, a sleeve, a compression union, a nut, a bolt, a clamp, a lock, and a wire. As is shown in FIGS. 6A-6E, a side wall 160 of a tank body 105 may include one or more lifting holes on a rim that protrudes along a horizontal plane away from an exterior surface of the side wall 160. Lifting holes may be advantageously used for transporting and storing a tank body 105. FIG. 6C illustrates a front view of the nestable water tank 400 where FIG. 6D illustrates a top perspective of the nestable water tank 400. FIG. 6E depicts a side view of the nestable water tank 400. As is shown in FIG. 6E, a disclosed nestable water tank lid 110 and tank body 105 may each have surfaces, features, or holes that may facilitate a fixation between them. For example, each of a lid 110 and a tank body 105 may include surfaces with tabs and holes for screws, bolts, and nuts.

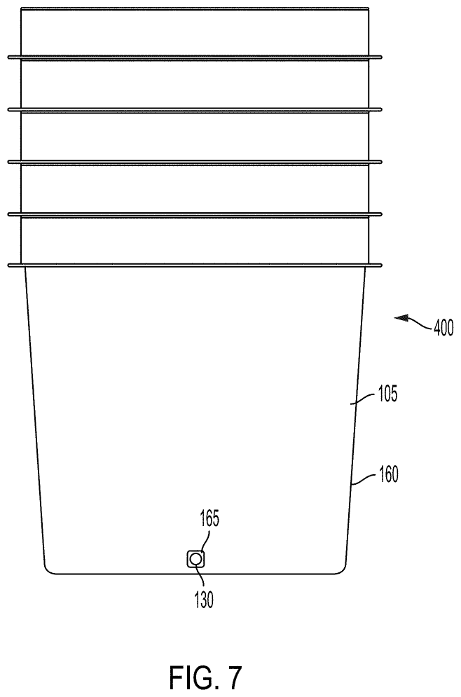

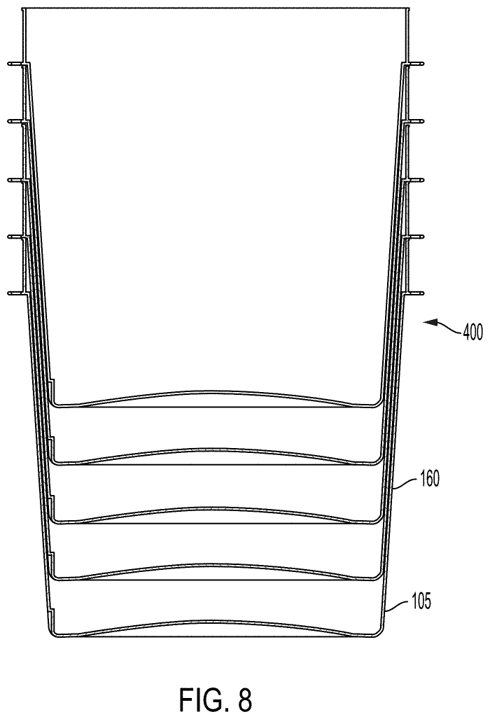

FIG. 7 depicts a front view of five tank bodies of nestable water tanks 400 that have been nested together. In some embodiments, for a tank body 105 to be nestable with another tank body 105, each of the tank bodies may be conical. FIG. 8 illustrates a cross-sectional side view of nested tank bodies of five nestable water tanks 400. According to some embodiments, a tank body 105 from a nestable water tank 400 may be nested together with from about 1 to about 20 tank bodies from other nestable water tanks 400. For example, a tank body 105 may be nested together with about 1 tank body, or about 2 other tank bodies, or about 4 other tank bodies, or about 6 other tank bodies, or about 8 other tank bodies, or about 10 other tank bodies, or about 12 other tank bodies, or about 14 other tank bodies, or about 16 other tank bodies, or about 18 other tank bodies, or about 20 other tank bodies, where about includes plus or minus 1 tank body.

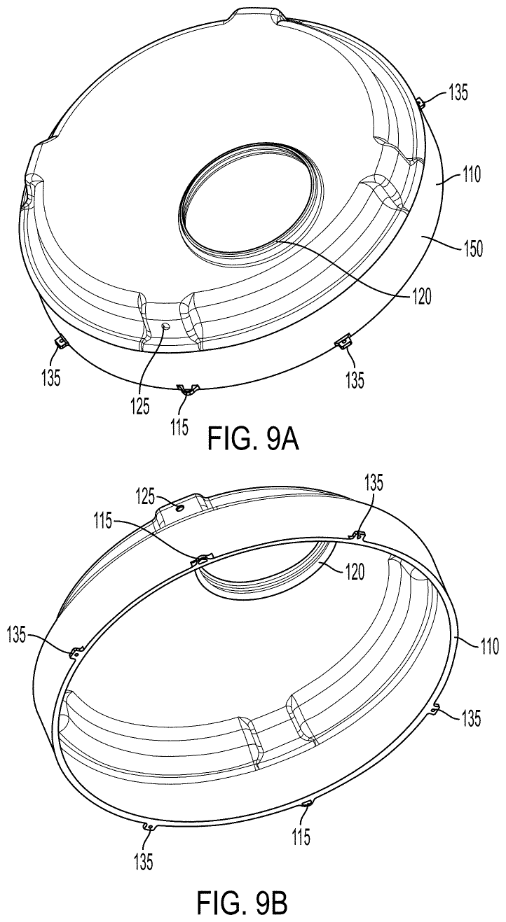

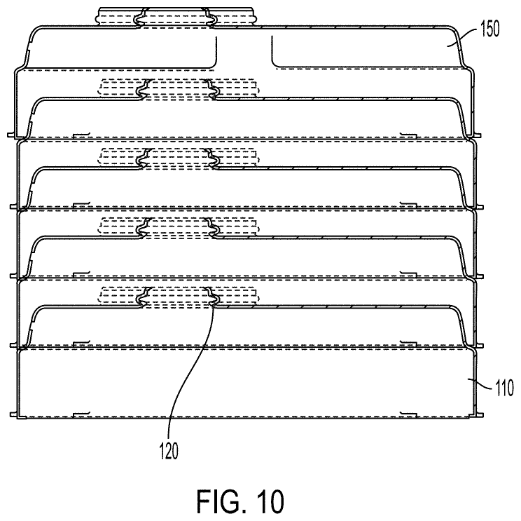

FIGS. 9A and 9B illustrates a top perspective view and a bottom perspective view of a nestable tank lid 110. FIG. 10 illustrates five lids 110 of nestable water tanks 400 that have been nested together. According to some embodiments, a lid 110 may be nested together with from about 1 to about 20 lids 110 from other nestable water tanks 400. For example, a lid 110 may be nested together with about 1 lid, or about 2 other lids, or about 4 other lids, or about 6 other lids, or about 8 other lids, or about 10 other lids, or about 12 other lids, or about 14 other lids, or about 16 other lids, or about 18 other lids, or about 20 other lids, where about includes plus or minus 1 lid.

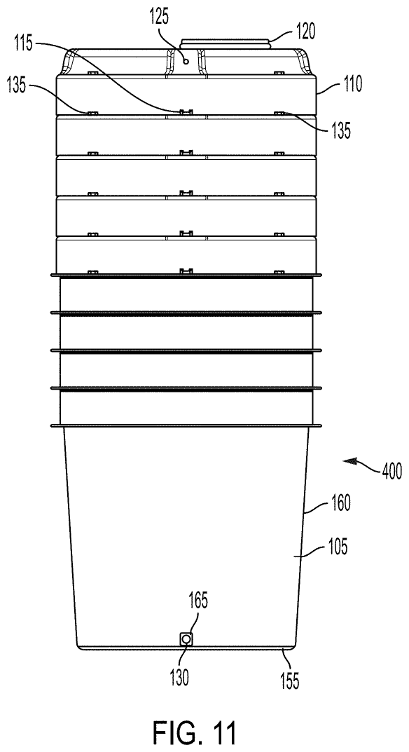

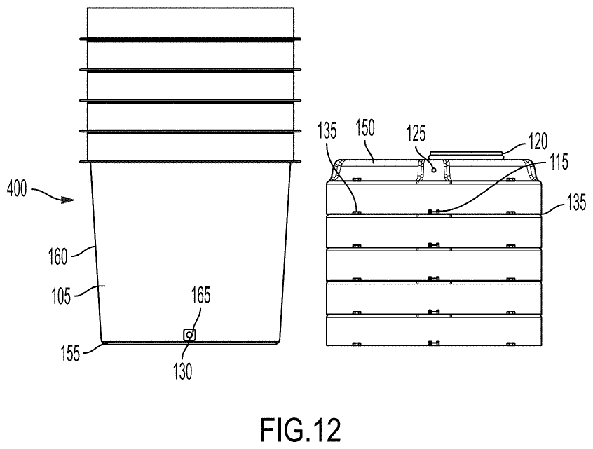

In some embodiments, tank bodies and lids 110 may be nested together, as is shown in FIG. 11, where five nestable water tanks 400 are nested together. In some embodiments, a tank body 105 and a lid 110 of a nestable water tank 400 are conical, which may permit nesting. A nestable water tank 400 may be nested together with about 1 other nestable water tank, or about 2 other nestable water tanks, or about 4 other nestable water tanks, or about 6 other nestable water tanks, or about 8 other nestable water tanks, or about 10 other nestable water tanks, or about 12 other nestable water tanks, or about 14 other nestable water tanks, or about 16 other nestable water tanks, or about 18 other nestable water tanks, or about 20 other nestable water tanks, where about includes plus or minus 1 nestable water tank. FIG. 12 illustrates another stacking pattern of a nestable water tank 400 where five tanks are stacked together and where five lids 110 are stacked together.

As will be understood by those skilled in the art who have the benefit of the instant disclosure, other equivalent or alternative devices, systems, and methods for manufacturing a nestable water tank 400 can be envisioned without departing from the description contained herein. Accordingly, the manner of carrying out the disclosure as shown and described is to be construed as illustrative only.

Persons skilled in the art may make various changes in the shape, size, number, and/or arrangement of parts without departing from the scope of the instant disclosure. For example, the position and number of caps, inlets, fluid connections, tanks, and discharges may be varied. In some embodiments, caps, inlets, fluid connections, tanks, and discharges may be interchangeable with like or different structures. Interchangeability may allow volume, shape, size, and nestability to be custom adjusted. In addition, the size of a tank, device and/or system may be scaled up (e.g., to be used for industrial embodiments) or down (e.g., to be used for portable embodiments) to suit the needs and/or desires of a practitioner. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of manufacturing and using a composition, device, and/or system of the disclosure.

In addition, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100.

All or a portion of a nestable water tank 400 may be configured and arranged to be disposable, serviceable, interchangeable, and/or replaceable. These equivalents and alternatives along with obvious changes and modifications are intended to be included within the scope of the present disclosure. Accordingly, the foregoing embodiments are intended to be illustrative, but not limiting, of the scope of the disclosure as illustrated by the appended claims.

Additionally, the section headings herein are provided for consistency with the suggestions under 37 C.F.R. § 1.77 or otherwise to provide organizational cues. These headings shall not limit or characterize the disclosure(s) set out in any claims that may issue from this disclosure. Specifically, a description of a technology in the “Background” is not to be construed as an admission that technology is prior art to any disclosure(s) in this disclosure. Furthermore, any reference in this disclosure to “disclosure” in the singular should not be used to argue that there is only a single point of novelty in this disclosure. Multiple disclosures may be set forth according to the limitations of the multiple claims issuing from this disclosure, and such claims accordingly define the disclosure(s), and their equivalents, that are protected thereby. In all instances, the scope of such claims shall be considered on their own merits in light of this disclosure, but should not be constrained by the headings herein.

What is claimed is:

1. A method for manufacturing a nestable water tank, the method comprising:
(a) molding a water tank comprising a hollow cylindrical body; and
(b) cutting the water tank along a horizontal plane of the cylindrical body to form the nestable water tank comprising a tank body and a lid,
wherein the tank body comprises:
(i) a side wall comprising a cylindrical shape running along a vertical axis, an interior surface, and an exterior surface; and
(ii) a bottom connected to a bottom portion of the cylindrical tank, together forming a nestable water tank interior space capable of storing water within the nestable water tank interior space and comprising an interior bottom surface and an exterior bottom surface, wherein the lid comprises:
(i) a top lid portion connected to a side wall and comprising a top surface and a bottom surface; and
(ii) the side wall comprising a bottom surface and a top surface that is connected to the bottom surface of the top lid portion, the side wall forming a hollow cylinder running along the vertical axis and comprising an inside surface and an outside surface, and
wherein at least one of the tank body is nestable with other similarly shaped tank bodies and the lid is nestable with other similarly shaped lids.

2. The method according to claim 1, wherein molding the water tank comprises:
(i) heating a polymer to a temperature ranging from about 180° C. to about 240° C. to form a melted polymer; and
(ii) extruding the melted polymer into a hollow mold shell to form an extruded polymer.

3. The method according to claim 2, wherein molding the water tank further comprises:
(iii) pressing air from a compressed air source into the extruded polymer to inflate the extruded polymer to fill the hollow mold, forming an inflated water tank; and
(iv) cooling the inflated polymer water tank to a temperature ranging from about 25° C. to about 60° C. to form the water tank.

4. The method according to claim 1, wherein molding the water tank comprises:
(i) filling a hollow mold with a polymer; and
(ii) rotating the hollow mold along at least one axis at a rotational speed ranging from about 1 rpm to about 100 rpm to form a rotating mold containing the polymer.

5. The method according to claim 4, wherein molding the water tank further comprises:
(iii) heating the rotating mold and the polymer contained therein to a temperature ranging from about 240° C. to about 280° C. of the hollow mold to form a melted polymer;
(iv) cooling the melted polymer to a temperature ranging from about 35° C. to about 70° C. while the melted polymer continues to rotate to form a cooled polymer; and
(v) stopping rotation of the cooled polymer to form the water tank.

6. The method according to claim 2, wherein the polymer comprises one or more of a polyethylene, a low density polyethylene, a high-density polyethylene, a linear low-density polyethylene, an ultra-high-molecular weight polyethylene, a medium-density polyethylene, a cross-linked polyethylene, a polyethylene terephthalate, and a polypropylene.

7. The method according to claim 2, wherein the polymer has a thickness ranging from about 0.5 mm to about 10 mm.

8. The method according to claim 2, wherein the polymer has a color comprising one or more of a black, a white, a red, an orange, a yellow, a green, a blue, an indigo, and a violet.

9. The method according to claim 1, wherein the tank body is nestable with from about 1 to about 20 similarly shaped tank bodies.

10. The method according to claim 1, wherein the lid is nestable with from about 1 to about 20 similarly shaped lids.

11. The method according to claim 1, wherein both of the tank body and the lid are nestable together with from about 1 to about 20 similarly shaped tank body and lid combinations.

12. The method according to claim 1, wherein the nestable water tank has a volume ranging from about 250 liters to about 5,000 liters.

13. The method according to claim 1, wherein molding the water tank comprises molding a multilayer tank, wherein, upon cutting the water tank, forms the nestable water tank comprising the tank body and the lid that each include from 1 layer to 5 layers.

14. The method according to claim 1, further comprising:
forming at least one lifting hole on a rim protruding in a horizontal plane away from the exterior surface of the side wall; and
forming at least one lifting hole protruding from the side wall of the lid.

15. The method according to claim 1, further comprising fastening the lid to the tank body using at least one of:
an adhesive,
a threaded connection,
a sleeve,
a compression union,
a nut,
a bolt,
a clamp,
a lock, and
a wire.

16. The method according to claim 1, further comprising forming a cap port on the top lid portion, wherein the cap port has a diameter ranging from about 25 cm to about 75 cm.

17. The method according to claim 1, further comprising forming a fill valve orifice through the side wall of the lid, wherein the fill valve orifice comprises a diameter ranging from about 10 mm to about 35 mm.

18. The method according to claim 1, further comprising forming a drain outlet on the sidewall of the tank body, wherein the drain outlet has a diameter ranging from about 20 mm to about 50 mm, wherein the drain outlet comprises a drain recess having a length and width, each ranging from about 60 mm to about 100 mm, and wherein the drain recess has a depth ranging from about 1 mm to about 25 mm.

19. The method according to claim 1, further comprising
forming at least one perforated protrusion in the lid that extends from the side wall of the lid and is configured to receive a bolt for fastening the lid to the tank body; and
forming at least one bolt hole on a rim protruding in a horizontal plane away from the exterior surface of the side wall, the at least one bolt hole configured to receive a bolt for fastening the lid to the tank body.

20. A method for manufacturing a nestable water tank, the method comprising:
cutting a water tank comprising a hollow cylindrical body, along a horizontal plane of the cylindrical body to form the nestable water tank comprising a tank body and a lid,
wherein the tank body comprises:
(i) a side wall comprising a cylindrical shape running along a vertical axis, an interior surface, and an exterior surface; and
(ii) a bottom connected to a bottom portion of the cylindrical tank, together forming a nestable water tank interior space capable of storing water within the nestable water tank interior space and comprising an interior bottom surface and an exterior bottom surface, wherein the lid comprises:
(i) a top lid portion connected to a side wall and comprising a top surface and a bottom surface; and
(ii) the side wall comprising a bottom surface and a top surface that is connected to the bottom surface of the top lid portion, the side wall forming a hollow cylinder running along the vertical axis and comprising an inside surface and an outside surface, and
wherein at least one of the tank body is nestable with other similarly shaped tank bodies and the lid is nestable with other similarly shaped lids.
